(19) United States
(12) Patent Application Publication
(10) Pub. No.: US 2026/0188305 A1
(43) Pub. Date: Jul. 2, 2026

(54) MODULAR MULTI-MODAL ENSEMBLE SELECTIVE ATTENTION SYSTEM

(71) Applicant: Attention Labs Incorporated, Newark, DE (US)

(72) Inventors: Bonny Banerjee, Collierville, TN (US); Daniyal Anjum, Milton (CA); Omar Abbasi, Guelph (CA); David J. Kim, Toronto (CA)

(21) Appl. No.: 19/386,258

(22) Filed: Nov. 12, 2025

Related U.S. Application Data
(63) Continuation of application No. 19/386,190, filed on Nov. 11, 2025.
Application No. 19/386,190 is a continuation of application No. 19/357,513, filed on Oct. 14, 2025.
Application No. 19/357,513 is a continuation-in-part of application No. 19/298,180, filed on Aug. 13, 2025.
Application No. 19/298,180 is a continuation of application No. 19/296,932, filed on Aug. 12, 2025.
Application No. 19/296,932 is a continuation of application No. 19/241,399, filed on Jun. 18, 2025.
Application No. 19/241,399 is a continuation of application No. 19/236,996, filed on Jun. 13, 2025.
Application No. 19/236,996 is a continuation of application No. 19/221,496, filed on May 28, 2025.
Application No. 19/221,496 is a continuation of application No. PCT/US25/29916, filed on May 18, 2025.
Application No. PCT/US25/29916 is a continuation-in-part of application No. 19/093,220, filed on Mar. 27, 2025.
Application No. 19/093,220 is a continuation of application No. 19/069,128, filed on Mar. 3, 2025.
(60) Provisional application No. 63/739,560, filed on Dec. 28, 2024.
(60) Provisional application No. 63/741,998, filed on Jan. 6, 2025.

(51) Int. Cl. G10L 15/02; G10L 15/16

(52) U.S. Cl. CPC G10L 15/02; G10L 15/16

(57) ABSTRACT

A selective attention system for multi-source or multi-speaker environments, including a plurality of independent selective attention (SA) models, each configured to output a probability distribution over a plurality of sources and a confidence score, a modular framework allowing said SA models to be added, replaced, upgraded or blocked in real time without interrupting system operation, an output fuser configured to combine outputs from said SA models based on at least one of model confidence and dynamically learned reliability scores, and a routing mechanism that directs user attention to a single source at a time based on the fused output.

### REFERENCE TO RELATED APPLICATIONS

This application claims the benefit of (i) U.S. Provisional Application No. 63/739,560 entitled ATTENTION MODELING IN MULTI-SPEAKER ENVIRONMENTS and filed on Dec. 28, 2024 by inventors David J. Kim, Omar Abbasi and Daniyal Anjum, of (ii) U.S. Provisional Application No. 63/741,998 entitled ATTENTION MODELING IN MULTI-SPEAKER ENVIRONMENTS and filed on Jan. 6, 2025 by inventors David J. Kim, Omar Abbasi and Daniyal Anjum, of (iii) U.S. patent application Ser. No. 19/069,128 entitled ATTENTION MODELING IN MULTI-SPEAKER ENVIRONMENTS filed on Mar. 3, 2025 by inventors David J. Kim, Omar Abbasi and Daniyal Anjum, of (iv) U.S. patent application Ser. No. 19/093,220 entitled SELECTIVE AUDITORY ATTENTION IN MULTI-PARTICIPANT ENVIRONMENTS filed on Mar. 27, 2025 by inventors David J. Kim, Omar Abbasi and Daniyal Anjum, of (v) U.S. patent application Ser. No. 19/221,496 entitled SELECTIVE AUDITORY ATTENTION IN MULTI-PARTICIPANT ENVIRONMENTS filed on May 28, 2025 by inventors David J. Kim, Omar Abbasi, Daniyal Anjum and Bonny Banerjee, of (vi) U.S. patent application Ser. No. 19/236,996 entitled DYNAMIC CONVERSATION GRAPH GENERATION filed on Jun. 13, 2025 by inventors David J. Kim, Omar Abbasi, Daniyal Anjum and Bonny Banerjee, of (vii) U.S. patent application Ser. No. 19/241,399 entitled DISTRIBUTED PROCESSING ARCHITECTURE FOR ATTENTION MODELING filed on Jun. 18, 2025 by inventors David J. Kim, Omar Abbasi, Daniyal Anjum and Bonny Banerjee, of (viii) U.S. patent application Ser. No. 19/296,932 entitled MULTI-PARTICIPANT CONVERSATION STATE DETECTION filed on Aug. 12, 2025 by inventors David J. Kim, Omar Abbasi, Daniyal Anjum and Bonny Banerjee, of (ix) U.S. patent application Ser. No. 19/298,180 entitled MULTI-PARTICIPANT VOICE ACTIVIY DETECTION filed on Aug. 12, 2025 by inventors David J. Kim, Omar Abbasi, Daniyal Anjum and Bonny Banerjee, of (x) U.S. patent application Ser. No. 19/357,513 entitled CONTEXT-AWARE DYNAMIC ATTENTION WITH CONVERSATIONAL GRAPHS AND UTILITY SCHEDULING filed on Oct. 14, 2025 by inventors Bonny Banerjee, David J. Kim, Omar Abbasi and Daniyal Anjum, of (xi) U.S. patent application Ser. No. 19/386,190 entitled UNIFIED SYSTEM FOR SELECTIVE ATTENTION IN MULTI-SOURCE ENVIRONMENTS filed on Nov. 11, 2025 by inventors Bonny Banerjee, David J. Kim, Omar Abbasi and Daniyal Anjum, and of (xii) PCT Application No. PCT/US25/29916 entitled SELECTIVE AUDITORY ATTENTION IN MULTI-PARTICIPANT ENVIRONMENTS filed on May 18, 2025 by inventors David J. Kim, Omar Abbasi, Daniyal Anjum and Bonny Banerjee, the contents all of which are incorporated herein by reference in their entireties.

### FIELD OF THE INVENTION

The field of the invention is sensory signal processing and machine learning.

### BACKGROUND OF THE INVENTION

In complex auditory environments, the human auditory system naturally focuses attention on specific speakers of interest while filtering out background noise, commonly known as the “cocktail party effect.” This biological capability enables selective attention to individual conversations in noisy environments. Modern wearable devices and mixed reality systems aim to replicate and enhance this natural ability, presenting both significant opportunities and technical challenges in multi-speaker scenarios.

Reference is made to FIG. 1, which is a prior art diagram of a “cocktail party effect”. Multiple conversations are taking place simultaneously at the party. Imagine if each participant is wearing a hearing device. From the perspective of a non-human, the audio output from a hearing device would correspond to a sum of simultaneous conversations. Any kind of audio processing would be very difficult if not impossible. In fact, even for the human ear, the ability to focus on any one of the simultaneous conversations is challenging.

Current technology enables basic speaker identification and audio processing in controlled environments. However, real-world social interactions involve dynamic groups, varying environmental conditions, and complex conversation patterns that exceed capabilities of existing systems. A technical challenge lies in developing comprehensive solutions that can handle the full complexity of natural multi-participant conversations while operating within constraints of wearable devices.

Key technical challenges in developing such systems include:
1. processing and analyzing multiple simultaneous audio streams in real-time while maintaining low latency;
2. operating efficiently on devices with limited computational resources;
3. adapting to changing group dynamics and conversation patterns;
4. integrating multiple data types including audio, spatial and participant interaction data;
5. maintaining privacy and security of conversation data;
6. managing attention across multiple concurrent conversation groups;
7. providing seamless audio transitions as attention shifts between speakers; and
8. scaling system performance with increasing numbers of participants.

Existing approaches to audio processing and speaker separation primarily focus on isolated aspects of the problem. Traditional audio processing methods lack the flexibility required for dynamic social scenarios. While machine learning approaches show promise, they often demand substantial computational resources that exceed capabilities of wearable devices. Rule-based systems struggle to handle complexity and uncertainty inherent in natural conversations.

### SUMMARY

There is thus provided in accordance with an embodiment of the present invention a selective attention system for multi-source or multi-speaker environments, including a plurality of independent selective attention (SA) models, each configured to output a probability distribution over a plurality of sources and a confidence score, a modular framework allowing said SA models to be added, replaced, upgraded or blocked in real time without interrupting system operation, an output fuser configured to combine outputs from the SA models based on at least one of model confidence and dynamically learned reliability scores, and a routing mechanism that directs user attention to a single source at a time based on the fused output.

### BRIEF DESCRIPTION OF THE DRAWINGS

The present invention will be more fully understood and appreciated from the following detailed description, taken in conjunction with the drawings in which:

FIG. 1 is a prior art diagram of a “cocktail party effect”;

FIG. 2 is a simplified diagram of attention patterns within the cocktail party shown in FIG. 1, in accordance with an embodiment of the present invention;

FIGS. 3-5 are simplified illustrations of various conversations to which selective auditory attention (SAA) may be applied, in accordance with embodiments of the present invention;

FIGS. 6A and 6B are a simplified flow diagram of a process for selective attention, in accordance with an embodiment of the present invention.

### DETAILED DESCRIPTION

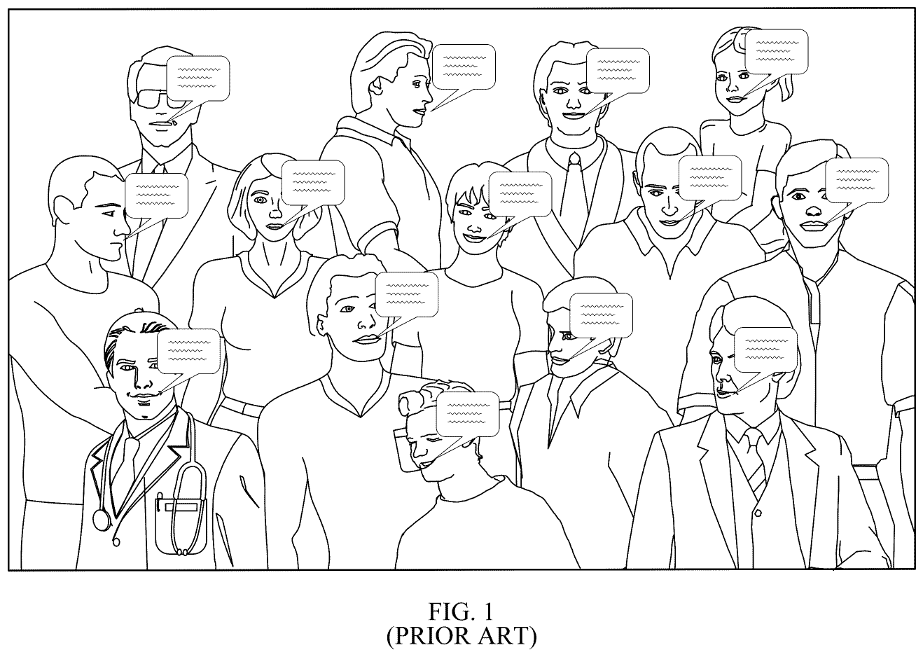

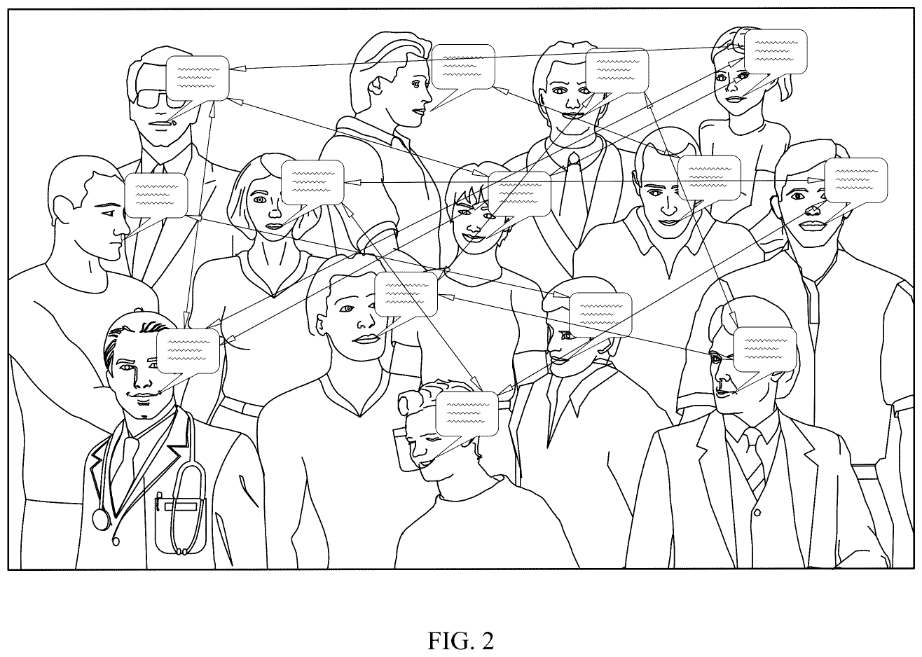

Reference is made to FIG. 2, which is a simplified diagram of attention patterns within the cocktail party shown in FIG. 1, in accordance with an embodiment of the present invention. Each participant is wearing a hearing device. For example, in one important embodiment, each participant is wearing smart glasses with hearing devices. In other embodiments, a participant may be wearing a smart helmet or smart goggles, or separate audio and video devices, such as headphones and glasses. The attention patterns are represented by arrows connecting participants participating in one of the many simultaneous ongoing conversations. The arrows form a “conversation graph” for which nodes represent participants and edges connect participants who belong to the same conversation group.

In practice, it may not be possible to determine with absolute certainty which participants belong to which conversation groups. As such, the conversation graph is expanded to include edges between participants who likely belong to the same conversation group. Each edge is weighted with a probability that the two participants jointed by the edge currently belong to the same conversation group. As such, the conversation graph may be considered to be a complete graph, with edges connecting each pair of participants, the edges being weighted with zero or positive weights.

Embodiments of the present invention analyze the participants using multimodal sensors including inter alia audio, visual and positional sensors, and using natural language processing (NLP), derive the conversation graph, and process the audio to amplify the conversation(s) that each participant is likely paying attention to and suppress conversation(s) that the participant is not paying attention to. Multimodal analysis uses cues such as inter alia the direction at which a participant is gazing, which of the other participants are gazing at him, body movements of the participant and of the other participants, and eye movements of the participant and of other participants. NLP analysis uses semantics to determine the conversation topic of current interest to the participant. Amplification and suppression of conversations is performed by applying large gain level to audio from a group conversation that a participant is currently paying attention to with high probability, and low gain levels to audio from group conversations that the participant is currently paying attention to with low probability.

In one embodiment of the present invention, the multimodal signal processing that derives the conversation graph is performed within the smart glasses themselves. In another embodiment of the present invention, the multimodal signal processing is performed by a central computing device, local or remote.

It is noted that the above analysis is dynamic. Conversation graphs are dynamic. A participant may transition from one conversation to another. New participants may arrive. Existing participants may leave.

Moreover, one or more participants may be non-human AI agents.

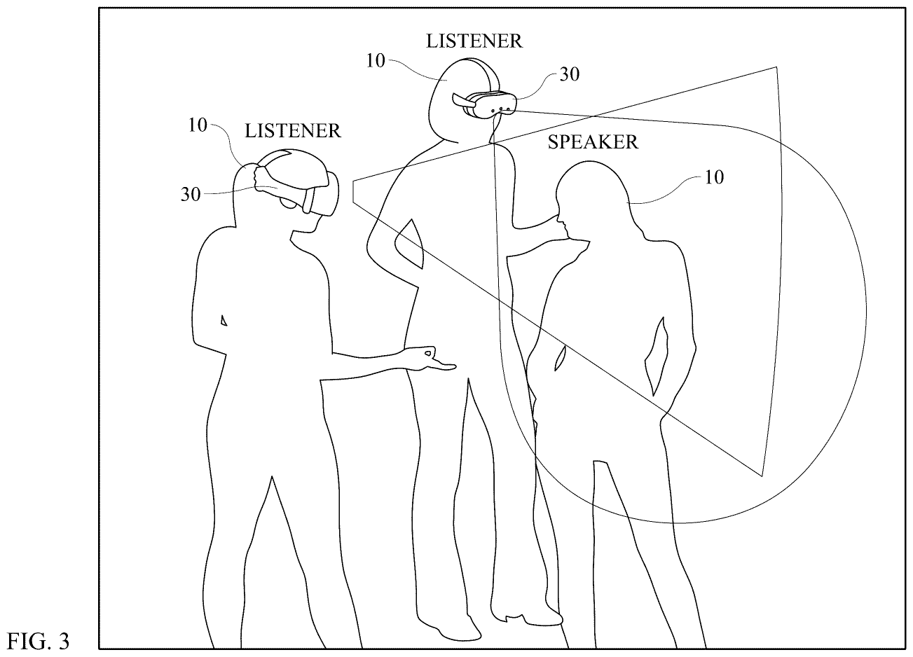

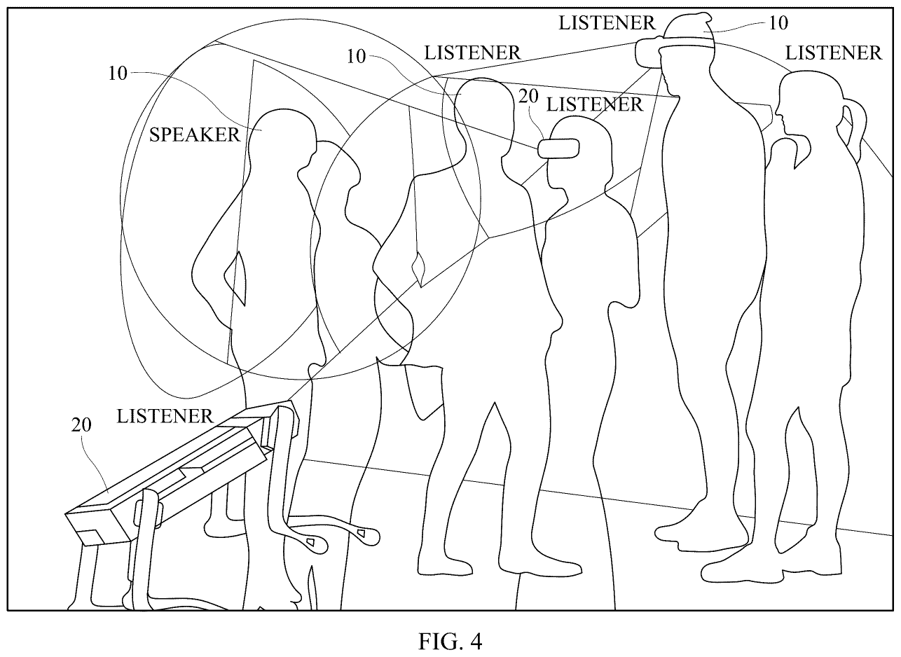

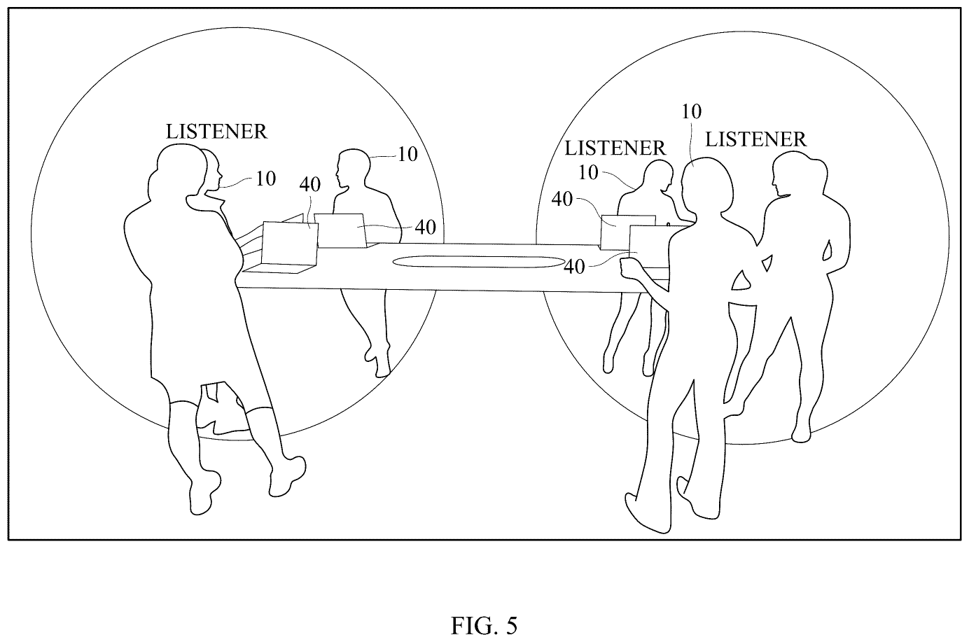

Reference is made to FIGS. 3-5, which are simplified illustrations of various conversations to which selective attention (SA) may be applied, in accordance with embodiments of the present invention. FIGS. 3-5 show participants 10 and an AI assistant 20, some of which are speakers and others of which are listeners, engaged in group conversations. Some participants are wearing smart goggles 30 and some participants are using laptop computers 40. Smart goggles 30 and laptop computers 40 include software enabling each listener to focus on a respective speaker.

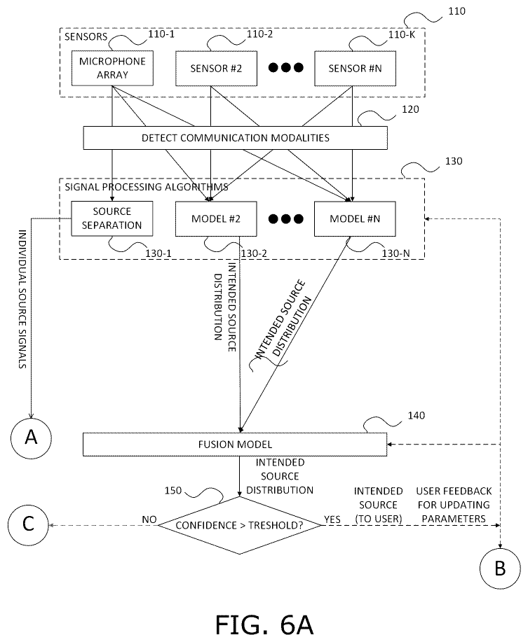

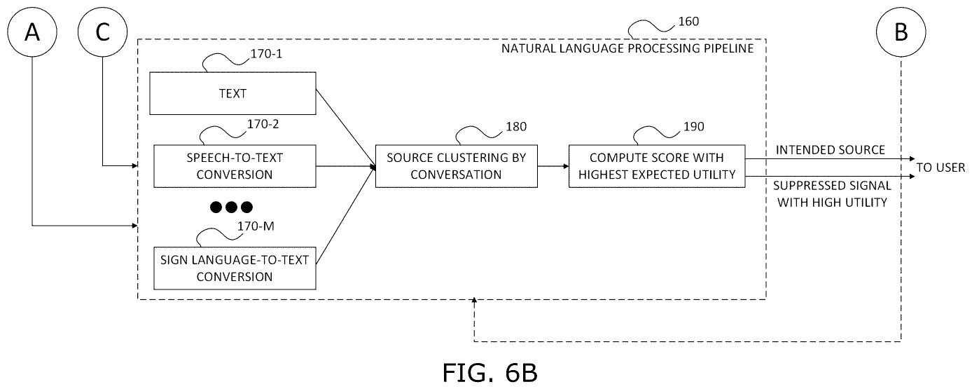

Reference is made to FIGS. 6A and 6B, which are a simplified flow diagram of an SA process, in accordance with an embodiment of the present invention. The process of FIG. 6 uses a unified model for selective attention that handles multiple communication modalities including inter alia text, speech, and sign language. Any of those modalities may be turned on or off at any time without affecting the rest of the system. Thus, if a user wishes to use only audio modality, e.g., due to privacy concerns in video or due to lack of appropriate video hardware, he simply blocks the models for other modalities on the fly over the air or via a user interface, e.g., on a smartphone or computer, and adds more audio models to satisfy his needs.

The SA process uses an open-ended number of independent SA models working in parallel. A model may be upgraded, replaced, added or removed at any time. The method will always be the state-of-the-art, as it will always perform at least as good as, if not better than, the state-of-the-art model, assuming the implementation details, or software code, of the state-of-the-art or a similarly performing model is available open source. This is because the models in the method may be updated/replaced on the fly over the air or using a user interface, e.g., on a smartphone or computer, without affecting the rest of the method.

New models may be added or any of the existing models may be blocked on the fly over the air or using a user interface, e.g., on a smartphone or computer, without affecting the rest of the system. Thus, if a user wishes to use only beamforming models, he simply blocks the other types of models and adds more beamforming models to satisfy his needs.

The SA process includes a natural language processing pipeline configured to receive a plurality of heterogeneous input modalities and systematically convert the inputs into a standardized textual representation. The method of FIGS. 6A and 6B includes input processing adapted to handle direct textual input, audio-to-text conversion via speech recognition algorithms, and additional modality processors including inter alia visual gesture interpretation for sign language translation, wherein each input processing module outputs normalized text data to a unified natural language processing pipeline. This multi-modal input architecture provides technical advantages, including improved accessibility across diverse user populations and scalable integration of future communication technologies without requiring modification to downstream processing components.

The SA process of FIGS. 6A and 6B takes into account multiple communication modalities, such as text, speech and sign language. The SA process uses natural language processing (NLP), in addition to eye gaze direction, to determine an intended source. A user is not always listening to the source he/it is looking at. When one talks to someone, he does not look at that person all the time. Sometimes one even talks to someone in another room separated by an opaque wall. Whom one is speaking to or who is speaking to him is not decided solely based on eye gaze direction but also from linguistic context. That is, NLP is important, and more so in a social setting, such as a party.

The SA process of FIGS. 6A and 6B incorporates dynamic attention shifting. A user may need to shift attention from one source to another, even while the first source is still talking to the user. The system learns user models, or source profiles, and uses a dynamic conversation graph to keep a memory of users' properties/characteristics and past, old and recent, interactions. This allows a user to make a faster and more accurate prediction of the source he/it wishes to attend to.

It is noted that a user of the SA process of FIGS. 6A and 6B may be a human or an AI agent.

FIGS. 6A and 6B show an array 110 of sensors 110-1, 110-2, . . . , 110-K of different modalities. Sensor 110-1 is a microphone array, sensor 110-2 may be, e.g., an inertial measurement unit, and sensor 110-K may be, e.g., an EEG. As described hereinbelow, operation 120 detects communication modalities for participants in a conversation.

FIGS. 6A and 6B show an array 130 of models 130-1, 130-2, . . . , 130-N. Model 130-1 separates audio signals from the participants into separated source audios. Each model 130-2, . . . , 130-N processes outputs of sensor array 110, and derives a probability distribution for whom the user, i.e., a specific participant, is paying attention to, referred to as an “intended source”. The probability distribution assigns, for each participant other than the user, a respective probability 0<=p<=1 to the participant, the probabilities summing to one. Model 130-1 may be, e.g., blind source separation, and model 130-2 may be, e.g., multimodal metadata.

Operation 140 fuses the various intended source probability distributions into a coherent and confident probability distribution. At operation 150 a decision is made whether the confidence level of the fused probability distribution exceeds a threshold level of confidence. If so, audio from the intended source is transmitted to the user, and the user may provide feedback which is used to updated parameters of signal processing algorithms 130.

If it is determined at decision 150 that the confidence level of the fused probability distribution does not exceed the threshold level of confidence, then the separated individual source signals are transmitted to a natural language processing pipeline 160.

Natural language processing pipeline 160 includes a text extractor 170-1 that extracts text from the individual source signals, a speech-to-text convertor 170-2, a sign language-to-text convertor 170-M, and possibly other convertors. At operation 180 the participants are clustered into conversation sub-groups, based on the extractors and convertors 170-1, . . . , 170-M, as described below. At operation 190 the expected utility of each source is computed, as described below, and the source with the highest expected utility is designated as the intended source that the user is paying attention to. Audio from the intended source is transmitted to the user, and audio from other participants is suppressed.

### I. 120: Detecting Communication Modalities

The SA process detects whether a person is communicating using speech or sign language in a video signal using multimodal analysis-specifically combining audio, visual, and optionally textual cues, as explained hereinbelow.

Preprocessing. The SA process receives as input a video stream with audio, and generates as output an audio stream and video frames, preferably at 25-30 FPS.

Audio-Based speech detection. This involves (i) voice activity detection (VAD), and (ii) speech content check.

VAD. A lightweight VAD (e.g., WebRTC VAD, Silero VAD) detects whether speech is present in the audio, and generates as output a binary. is_speech_present, per frame or segment.

Speech content check. ASR (automatic speech recognition) determines if recognized content is meaningful, which helps disambiguate background speech.

Vision-based sign language detection. This involves (i) pose and hand tracking, (ii) gesture activity analysis, and (iii) sign language classification.

Pose and hand tracking. A body/hand keypoint detection system, e.g., MediaPipe Holistic, OpenPose, PoseLandmark or BlazePose, extracts hand gestures, arm movements and facial expressions.

Gesture activity analysis. Computes motion intensity and frequency of hand/arm gestures in front of torso/head. Applies heuristic or a machine learning (ML)-based classifier to distinguish between casual gestures, e.g., pointing or waving, and structured gesturing patterns, which are characteristic of sign language.

Sign language classifier. For a high confidence result, a lightweight sign language detection model, e.g., CNN+RNN, or transformer on keypoint sequences, is trained to classify signing vs. non-signing.

Communication mode decision logic.

```
if is_speech_present and not signing_detected:
    mode = “speech”
elif not is_speech_present and signing_detected:
    mode = “sign language”
elif is_speech_present and signing_detected:
  mode = “bimodal” // speech + sign (common in deaf/hard-of-
  hearing contexts)
else:
    mode = “non-communicative” or “unknown”
```

TABLE I below summarizes key features for decision making.

TABLE I
Key features for decision making

| Modality | Feature | Indicates |
|---|---|---|
| Audio | Speech activity | Vocal communication |
| Video | Hand motion patterns | Signing |
| Video | Hand location (near | Structured signs |
| | face/torso) | |
| Video | Facial expressions | Integral to some sign languages |
| | | (e.g., ASL) |
| Audio + | Co-timing | Helps disambiguate gesture vs. |
| Video | | sign |

Edge cases and considerations include the following. Bimodal communication (speech+sign). Common in some Deaf/HOH (hard of hearing) communities. Ambient speech. Distinguish if person is speaking or if background noise. Gesture vs. sign. Casual gestures may look like signs-temporal consistency and facial expression help. Low-light or occlusions. Degrade vision-based accuracy.

In summary, low-light or occlusions degrade vision-based accuracy. To detect speech vs. sign communication use (i) VAD to detect speech presence, and use (ii) pose/hand tracking+motion analysis to detect signing. Fuse both signals to decide: speech, sign, both, or neither.

### II. 140: Fusion Model

To fuse multiple probabilistic attention estimators into a more accurate and confident ensemble output, combine their probability distributions in a principled way—while also respecting each model's confidence.

The SA process uses a structured approach to confidence-weighted probabilistic fusion, which improves accuracy and robustness over simple averaging or voting.

The SA process uses N independent models, 130-1, . . . , 130-N, indexed by i, each model 130-i outputs (i) a probability distribution over K sources: P_i=[p_i1, p_i2, . . . , p_iK], and (ii) a confidence score c_i=max(P_i)∈[0, 1]. The SA process generates a fused distribution P_fused=[p_1, p_2, . . . , p_K], which reflects the weighted belief over sources, and has higher accuracy and sharper confidence.

A fusion method using confidence-weighted logit averaging is now described.

Convert distributions to logits. Softmax probabilities are bounded and may be too “soft”. The SA process converts each P_i to logits (unnormalized scores): L_i=log (P_i+ϵ), where ϵ is a small constant, e.g., 1e-9, to avoid log (0).

Weight logits by confidence. The SA process scales each model's logits by its confidence: \tilde{L}_i=c_i·L_i. This boosts confident predictions and downweighs uncertain ones.

Aggregate weighted logits. L_fused=sum_{i=1}\hat{ }{N}\tilde{L}_i.

Normalize into final probabilities. P_fused=softmax(L_fused). This gives a final distribution over sources. The source with the highest P_fused[j] is the attended source, and the value is the confidence.

An alternative fusion method using weighted averages is now described.

An alternative method that is faster but less stable proceeds as follows. P_fused=(1/Z)·\sum_{i=1}\hat{ }{N} c_i·P_i, where Z=sum_{i=1}\hat{ }{N} c_i(normalization constant). This method assumes confidence-weighted sum of probabilities.

Confidence-weighted logit averaging handles disagreement between models gracefully, by downweighing low-confidence ones, boosts agreement among confident models, and avoids mode collapse that may happen with plain softmax averaging.

An alternative fusion method uses self-attention fusion. What follow is a procedure for a self-attention fusion method for combining multiple probabilistic attention estimators into a single, more accurate and confident ensemble output.

Gather model inputs. For N independent models, each provides (i) a probability distribution over K sources: P_i=[p_{i1}, p_{i2}, . . . , p_{iK}], (ii) a confidence score: c_i=max_j p_{ij}, and (iii) a dynamic trust score from reliability model: r_i∈[0, 1].

Build feature representation of each model output. For each model i, form a feature vector: x_i=[P_i, c_i, r_i, contextfeatures], where context features may include inter alia source profile match, noise level, and modality match.

Using a self-attention mechanism α_i=exp((x_i·W_Q)·(X·W_K)′/sqrt{d})/sum_{m=1}\hat{ }N exp((x_m·W_Q)·(X·W_K)′/\sqrt{d}), where W_Q, W_K are learnable weight matrices, X is the matrix of all x_i, and α_i∈[0,1] is the learned fusion weight for model i based on relationships between all model outputs.

Fuse probability distributions. Weighted sum of model probability vectors: P_{final}=sum_{i=1}\hat{ }N α_i·P_i.

Compute final confidence. Final confidence score: c_{final}=max_j P_{final, j}.

Output decision. Attended source: argmax_j P_{final, j}. Final confidence: c_{final}.

Update trust scores (offline/online). After ground-truth or delayed validation, update r_i for each model to influence future self-attention weighting.

An alternative fusion uses multi-layer perceptron (MLP). What follows is a procedure for using a MLP to combine multiple probabilistic attention estimators into a single, more accurate and confident ensemble output.

Collect model outputs. For N models, (i) probability distributions: P_i=[p_{i1}, p_{i2}, . . . , p_{iK}], (ii) confidence scores: c_i=max_j p_{ij}, and (iii) trust scores: r_i∈[0, 1].

Form input feature vector. Concatenate all features into one vector: X_{input}=[P_1, c_1, r_1, . . . , P_N, c_N, r_N, contextfeatures].

Pass-through MLP fusion network. Layer 1: Dense layer+activation (e.g., ReLU). Layer 2: Dense layer+activation. Output Layer: Softmax over K sources. P_{final}=Softmax(MLP(X_{input})).

Extract final decision and confidence. Attended source: argmax_j P_{final, j}. Final confidence: c_{final}=max_j P_{final, j}.

Update model trust scores. After delayed or offline validation, adjust r_i to improve future fusion accuracy.

Several enhancements to the SA process fusion methods are now described.

Model calibration. Ensure each model's confidence (max probability) actually reflects its accuracy. Bayesian fusion. If P_i are modeled as independent posteriors, use product-of-experts P_fused proportional to \product_i P_i\hat{ }{c_i}. Entropy filtering. Discard models with high entropy (very uncertain) before fusing.

Conflict Resolution. When multiple models yield high-confidence predictions (c_i>0_{conflict}), the method implements conflict resolution as part of fusion to decide which one of the K sources to attend to at any point of time. A sequence of operations to implement conflict resolution is provided hereinbelow.

Given N independent models, each model i outputs (i) a probability distribution over sources: P_i=[p_i1, p_i2, . . . , p_iK], and (ii) a confidence score: c_i=max (P_i)∈[0, 1].

The objective of conflict resolution is to derive a final distribution \hat{P}=[\hat{p}_1, . . . , \hat{p}_K] or a final attended source \hat{k}*=argmax_k \hat{p}_k.

A conflict occurs when c_i>θ_{conflict} for more than one model i. Let H={i∈{1, . . . , N} such that c_i>θ_{conflict}}. Let M=|H| be the number of such models. Maintain a dynamic trust score r_i∈[0, 1] for each model based on past performance, updated offline or online. Fuse the distributions by weighted average. Update fusion weights: w_i=(c_i·r_i)/(sum_{j∈H}c_j·r_j). \hat{P}=sum_{i∈H}w_i·P_i. The final attended source is \hat{k}*=argmax_k \hat{p}_k.

The fusion model may be enhanced by diversity regularization; namely, penalizing prediction as needed. DiversityPenalty=KL(P_i∥P_j) for i≠j. A regularizer may be added to prefer consensus over outliers.

The fusion model may be enhanced by interpretation. This enhancement ensure that only models with sufficient confidence contribute, that models contribute in proportion to their confidence and reliability, and that the final attention decision respects multiple signals and avoids over-trusting any single model.

The final output of fusion model 140 includes (i) a probability distribution over sources: P_fused, (ii) attended source: argmax (P_fused), and (iii) confidence: max (P_fused).

### III. 150: Define Confidence Threshold

Defining a confidence threshold for the ensemble model's output is important for deciding whether to trust its decision, e.g., selecting an attended source, or defer to fallback mechanisms, e.g., human override or wait for more data. Below is a structured way to define such a threshold.

The SA process receives a final ensemble output: a probability distribution P_fused over K sources, let p_max=max(P_fused)=the ensemble's confidence. The SA process determines a threshold T such that If p_max≥T, then the prediction is trustworthy.

Methods to define the threshold include the following. Empirical calibration. Use a held-out validation set with ground truth to find a threshold that best separates correct and incorrect predictions. The method includes (i) for many ensemble predictions, record:p_max, whether the prediction (argmax) was correct; (ii) plot accuracy vs. confidence curve (a reliability diagram); and (iii) choose the smallest threshold T such that accuracy≥target (e.g., 90%) OR false positive rate≤acceptable limit. This yields a data-driven confidence threshold that is tailored to the model and task.

Entropy-based threshold. Instead of, or in addition to, p_max, use the entropy of P_fused as a confidence measure: Entropy (P)=−sum_{i=1}\hat{ }{K} p_i·log (p_i). Lower entropy implies more confident distribution. Define a maximum entropy H_max (threshold). If Entropy(P_fused)<H_max, trust the decision. This is useful when the top probability is only marginally higher than others.

Fixed margin heuristic (simple and fast but brittle). Define a margin between top two probabilities: Margin=p_max−p_secondmax. If Margin>δ (e.g., 0.2), trust the output. This ensures the system is not confused between top contenders.

Confidence threshold via ROC curve. If trustworthiness is defined as a binary classification task, compute ROC or precision-recall curves using p_max or entropy as the score. Choose threshold T based on: desired true positive rate, and acceptable false positive rate.

TABLE II below summarizes criteria for trustworthiness.

TABLE II
Criteria for trustworthiness

| Measure | Threshold Type | Trustworthy if . . . |
|---|---|---|
| p_max | Confidence | p_max ≥ T |
| | threshold | |
| Entropy | Uncertainty | Entropy(P_fused) ≤ |
| | threshold | H_max |
| Margin (p_max − | Clarity threshold | p_max − p_secondmax ≥ |
| p_secondmax) | | δ |
| Calibrated ROC AUC | Statistical method | FPR ≤ x %, TPR ≥ y % |

The recommended best practice is to combine 1 and 2. I.e., use p_max for primary threshold (simple and fast) and use entropy as a secondary check when p_max is borderline (e.g., 0.6-0.8).

Context aware adaptive/dynamic threshold. A context-aware adaptive confidence threshold for a multi—source attention system builds on the four earlier methods—empirical calibration, entropy-based, margin heuristics, and ROC analysis—and incorporates contextual cues from source profiles and model reliability. Source profiles include learned characteristics of each source, e.g., topic, speech pattern, familiarity and emotional valence. Model reliability incudes dynamic trust scores r_i∈[0,1], updated over time. An advantage is that the threshold dynamically reflects both the current context and confidence in the models and sources.

Instead of a fixed threshold θ_{conflict}, define a contextual adaptive threshold for each model i and/or source k; namely, θ_{adaptive}(i, k, t)=f(Profile(k), r_i(t), Env(t)), where Profile(k) designates features of source k (e.g., familiarity, past attention alignment, topical salience), r_i(t) designates current trust score of model i, and Env(t) designated an optional context, e.g., SNR, group size, and/or user activity.

Profile-weighted entropy threshold. Define entropy of a distribution P_i as: H(P_i)=−sum_k p_{ik}·log p_{ik}. Define a maximum tolerable entropy based on profile familiarity: θ_H(k, t)=θ_0−λ·Familiarity(k). Then model i's prediction for source k is accepted if: H(P_i)<θ_H(k, t) If the source is well-known, then tighter thresholds (lower entropy) are allowed. If the source is unknown or ambiguous, then more uncertainty is allowed.

Trust-weighted confidence threshold. Define: θ_{conf}(i, k, t)=θ_0−α·r_i(t)+β·(1−ProfileConfidence(k)), where r_i(t) designates model reliability-more reliable models may have lower thresholds (more trusted), and ProfileConfidence(k) designates uncertainty certainty about source k's profile, e.g., from profile classifier margin or posterior variance. Accept P_i for model i if max_k p_{ik}>θ_{conf}(i, k, t).

Adaptive margin heuristic with source priors. Instead of a fixed margin between top two classes, define Δ_i=p_{i, k*}−p_{i, k{(2)}}, and require: Δ_i>θ_Δ(k*)=θ_0−γ. Predictability(k*), where Predictability(k*) designates variance of predictions for this source across models/time. For this method, less predictable sources require higher confidence margins.

Profile-aware ROC thresholding. During offline learning, (i) build ROC curves for each model i, but stratify the data by source profile clusters, e.g., familiar speaker, background music, unfamiliar voice, and (ii) learn optimal thresholds per source class or cluster: θ_i\hat{ }{(c)} for source cluster c. Then at test time: θ_{roc}(i, k)=θ_i\hat{ }{c(k)}, where c(k)=cluster of Profile(k). This makes thresholds aware of source type, e.g., stricter for background music, more forgiving for known speaker.

Putting it all together, define θ_i(k, t)=θ_0−α_1·r_i(t)−α_2·Familiarity(k)+α_3. Uncertainty(k), where the term α_1·r_i(t) is trust-aware, the term α_2·Familiarity(k) is profile-aware, and the term α_3·Uncertainty(k) is risk-aware. Uncertainty(k) may be high prediction entropy, low agreement across models, or low profile confidence. θ_i(k, t) may be dynamically updated. P_i is accepted only if max_k p_{ik}>θ_i(k, t).

TABLE III below summarizes the benefits of these terms.

TABLE III
Summary of benefits for fusion

| Property | Enabled By |
|---|---|
| Adaptive to model quality | r_i(t) |
| Adaptive to source profile | Profile(k), familiarity, uncertainty |
| Flexible across environments | Env(t) |
| Personalized thresholding | Combines past interaction history |

### IV. 180: Source Clustering by Conversation

Dynamic conversation graph. To model conversational attention dynamics in a multi-source environment, such as a party, the SA process uses a dynamic conversation graph. The nodes of the graph include sound sources V={v_1, v_2, . . . , v_N}. Sound sources include speakers, listeners, and any other sound source (e.g. music, traffic). The directed edges of the graph include attention weights from listener v_i to source v_j, denoted a_t\hat{ }{(i→j)}∈[0, 1]. This gives a time-varying attention-weighted directed graph: G_t=(V, E_t), where E_t={i→j, a_t\hat{ }{(i→j)}}.

Representing conversational attention history. Define a time-series of attention matrices, A_t∈R\hat{ }{N×N}, where R is set of real numbers, and A_t represents an attention matrix at time t. Element [A_t]_{ij}=a_t\hat{ }{(i→j)} represents how much attention node i gives to node j at time t. Define attention history as A_{1:T}={A_1, A_2, . . . , A_T}. This collection forms a temporal attention graph sequence, like a dynamic graph signal.

Online/incremental update of the attention graph. Assume that at each time step t, for each individual i, a distribution over sources is estimated: a_t\hat{ }{(i)}=AttentionDist(x_t\hat{ }{(i)}, {x_t\hat{ }{(j)}}_{j=1}\hat{ }N), where x_t\hat{ }{(i)} represents observed features of node i, e.g., audio, gaze and/or position, and a_t\hat{ }{(i)}∈R\hat{ }N represents an attention vector of node i over all nodes. Then, the attention matrix at time t is: [A_t]_{ij}=a_t\hat{ }{(i→j)}=probability that i attends to j.

Incremental update (exponential smoothing of attention history). For real-time processing, use an exponential moving average to update history: \hat{A}_t=(1−α)·\hat{A}_{t−1}+α·A_t, where \hat{A}_t represents a smoothed estimate of attention history, and α∈(0,1) represents a learning rate (controls memory decay). This provides a continuous, memory-efficient representation of evolving attention patterns.

Attention graph as a Markov chain. If attention values are normalized: each row a_t\hat{ }{(i)} sums to 1. Then A_t becomes a row-stochastic matrix, i.e., a discrete-time Markov process where attention flows from node to node.

Following is a summary of the key equations.

a_t\hat{ }{(i)}=softmax(f(x_t\hat{ }{(i)},{x_t\hat{ }{(j)}}_{j})) is the Attention vector over all j. Attention estimation (per individual):

[A_t]_{ij}=a_t\hat{ }{(i→j)}. Attention Matrix:

G_t=(V,E_t),E_t={(i→j,a_t\hat{ }{(i→j)})} Graph Construction:

\hat{A}_t=(1−a)·\hat{A}_{t−1}+α·A_t. Incremental Update of History:

Attention History: \hat{A}_t is used to identify stable conversational groups (strong mutual attention) as follows. To identify stable conversational groups using the smoothed attention matrix \hat{A}_t, the SA process looks for clusters of nodes (sources) that exhibit strong, reciprocal attention over time.

Intuitively, a conversational group at time t is a set of nodes G⊆V such that members of G strongly attend to one another, and the attention is mutual and sustained over time, captured by \hat{A}_t.

Thresholding for strong attention. Construct a binary graph B_t from \hat{A}_t to represent strong attention: if \hat{A}_t[i, j]>θ, [B_t]_{ij}=1; else [B_t]_{ij}=0·θ∈(0,1) designates a predefined attention threshold, e.g., 0.5. This creates a directed unweighted graph of “who is attending to whom”. One way to dynamically estimate this threshold is: θ=mean of [B_t]_{ij} over all i, j.

Enforce mutuality. To enforce bidirectional attention, define a mutual attention graph M_t: if [B_t]_{ij}=1 and [B_t]_{ji}=1, [M_t]_{ij}=1; else [M_t]_{ij}=0. Now, M_t is an undirected graph encoding reciprocal attention.

Find Connected Components. Apply a graph clustering algorithm (e.g., connected components or community detection) on M_t to extract stable groups. Each connected component in M_t represents a group of sources mutually attending to one another. This yields: G_t={G_1, G_2, . . . , G_K} where each G_k⊆V is a conversational group.

Stability over time. To assess stability, compare G_t with G_{t−1}. Define a stability score for a group G_k as: Stability (G_k, t)=|G_k∩G_k\hat{ }{(t−1)}|/|G_k∪G_k\hat{ }{(t−1)}|. Track groups that remain unchanged across multiple t's.

TABLE IV below summarizes key equations.

TABLE IV
Summary of key equations

| Step | Equation |
|---|---|
| Thresholding | if \hat{A}_t[i, j] > θ, [B_t]_{ij} = 1; else [B_t]_{ij} = |
| | 0 |
| Mutual | if [B_t]_{ij} = 1 and [B_t]_{ji} = 1, [M_t]_{ij} = 1; |
| attention | else [M_t]_{ij} = 0 |
| Clustering | Connected components on M_t |
| Stability | \|G_k ∩ G_k\hat{ }{(t − 1)}\| / \|G_k ∪ G_k\hat{ }{(t − 1)}\| |

The SA process interprets results as follows. High mutual attention=likely engaged in conversation. Group stability=persistent interaction. Weak or one-way attention=distraction, interest shift, or peripheral attention.

Attention History: The SA process uses \hat{A}_t to identify switching attention (e.g., person shifts focus to new speaker) as follows. To identify attention switching using the smoothed attention matrix \hat{A}_t, the SA process monitors how the distribution of attention for each individual changes over time-particularly, who the dominant target of attention is, and when that target changes.

The rationale is as follows. Let \hat{A}_t[i, j] be the smoothed probability that individual i is attending to source j at time t. Define the dominant attention target of i at time t: j*_t(i)=argmax_j \hat{A}_t[i, j]. Then, the SA process detects a switch in attention if j*_t(i)≠j*_{t−1}(i). That is, the individual i's most attended-to source has changed between t−1 and t.

Identify dominant target per time step. For each individual i: j*_t(i)=argmax_j \hat{A}_t[i, j].

Compare across time. Detect switch: if j*_t(i)≠j*_{t−1}(i), Switch_t(i)=1; else Switch_t(i)=0.

Thresholding for Significance. To reduce false positives, the SA process enforces a confidence margin: \hat{A}_t[i, j*_t(i)]>θ_{conf}. The SA process only counts a switch if the new dominant attention is strong enough (e.g., θ_{conf}=0.6). Also optionally ensure the new target stays dominant for a few steps (e.g., minimum dwell time).

Attention switch score. Define a continuous measure of how abruptly attention is shifting using cosine distance or KL divergence: SwitchScore_t(i)=D_{KL}(\hat{A}_{t}[i, . . . ]∥\hat{A}_{−1}[i, . . . ]), or SwitchScore_t(i)=1−\cos (\hat{A}_t[i, . . . ], \hat{A}_{t−1}[i, . . . ]). Higher score implies larger change in attention distribution. Smoothing/denoising. Since attention fluctuates momentarily, the SA process uses a temporal median filter over the dominant target sequence to stabilize detection. The SA process only tracks sustained changes.

TABLE V below summarizes key interpretation.

TABLE V
Interpretation

| Signal | Meaning |
|---|---|
| j*_t(i) ≠ j*_{t − 1}(i) | Speaker i is now attending to someone else |
| Repeated switching | Divided or unfocused attention |
| Stable dominant j*_t(i) | Focused on one speaker |

Visual detection. Plotting j*_t(i) over time for each individual creates a time series showing who they attend to—switching events appear as step changes in the series.

Attention History: The SA process uses \hat{A}_t to identify isolated sources (nodes with no inbound edges) as follows. To identify isolated sources using the smoothed attention matrix \hat{A}_t, the SA process looks for nodes that receive very little or no attention from any other nodes—that is, their inbound attention is near zero.

The rationale is as follows. Let \hat{A}_t[i, j]∈[0, 1] be the attention weight from node i(a listener) to node j (a source). Then the total inbound attention to node j at time t is Inbound_t(j)=\sum_{i≠j} \hat{A}_t[i, j]. If this sum is very small (or zero), then node j is not being attended to by anyone—i.e., it is an isolated source.

Compute inbound attention for each node. Inbound_t(j)=\sum_{i≠j}\hat{A}_t[i, j]

Define a threshold for isolation. The SA process sets a small threshold ϵ∈[0, 1] (e.g., 0.05), and declares node j isolated if Inbound_t(j)<ϵ. This allows a small amount of noise or residual attention without falsely disqualifying a node.

Tracking isolation over time. The SA process tracks how long a node remains isolated: if Inbound_t(j)<ϵ, IsolationDuration_t(j)=(1−β). IsolationDuration_{t−1}(j)+β·1; else IsolationDuration_t(j)=(1−β). IsolationDuration_{t−1}(j)·β∈[0, 1] is a constant that helps to discount past isolation and emphasize recent isolation. Nodes with sustained low inbound attention are considered long-term isolated, e.g., ignored speakers, unattended music or disengaged participants.

TABLE VI below summarizes the key equations.

TABLE VI
Summary of key equations

| Step | Equation |
|---|---|
| Inbound attention | Inbound_t(j) = \sum_{i ≠ j} \hat{A}_t[i, j] |
| Isolation check | Inbound_t(j) < ϵ |
| Duration tracking | See formula above |

TABLE VII below summarizes interpretation.

TABLE VII
Interpretation

| Signal | Meaning |
|---|---|
| Inbound_t(j) \approx 0 | Node j is not being attended to |
| IsolationDuration_t(j) | Node is persistently ignored |
| Sudden drop in inbound | Group disengagement, attention |
| attention | switching |

### V. Learning and Exploiting Source Models or Profiles

It is helpful for a listener to learn a model or profile of each source (including itself) to decide which source to attend to at any instant. This learned knowledge allows the listener to make informed, goal-directed attention decisions in a dynamic, multi-source environment.

The following are rationales why it helps.

Contextual relevance. A source profile may include its topic, emotion, speaker identity, or role, e.g., music, conversation or announcement. The listener then prioritizes sources relevant to its current goal. E.g., prefer voices speaking on topics it finds interesting or emotionally urgent.

Self-awareness & personalization. A self-profile allows the listener to incorporate its own interests, history, and attention biases. E.g., if the listener has been in a prior conversation, it may choose to continue attending that speaker. Self-modeling helps avoid irrelevant or repetitive information.

Temporal consistency and expectation. Learned profiles help form expectations about how sources behave over time. E.g., a known speaker might speak in bursts or tend to ask questions. Attention may be preemptively shifted or maintained based on these expectations.

Disambiguation in overlap. When multiple sources generate signals simultaneously, the listener uses the source profiles to resolve ambiguity (who is saying what?), and to attend to the more informative or trustworthy source.

Representing and using source profiles. Let the listener be node i, and sources j∈{1, . . . , N}.

Define a source profile. p_j=Profile(v_j)=[identity_j topicdistribution_j communicationstyle_j emotion_j role_j attention history_j]. Each source profile is dynamic and is updated to reflect changes in a speaker's emotion, role and context. The listener is also considered a source as the listener can be a speaker. The listener's profile is defined, stored and updated as the profile of any other source. The listener does not want to listen to any other source while he/she is speaking. Hence, the listener is the chosen source whenever one of the speakers in a multi-speaker environment is the listener.

Let the listener's goal or interest embedding be g_i=ListenerGoal(v_i). Then, the listener scores each source s_t\hat{ }{(i→j)}=Similarity (g_i, p_j)+λ·ContextualCue(x_t\hat{ }{(j)}). Finally, the attention distribution becomes a_t\hat{ }{(i)}=softmax(s_t\hat{ }{(i→j)}) over j. This allows the listener to make attention decisions that are both context-aware and personalized.

TABLE VIII below summarizes benefits.

TABLE VIII
Benefits

| Feature | How it helps |
|---|---|
| Source profiles | Encode semantic, emotional, and behavioral |
| | traits of sources |
| Self-profile | Models listener's interests, intent, and memory |
| Improved decision- | Attend based on relevance, trust, novelty, or |
| making | urgency |
| Resilience | Handle overlapping speech or background noise |
| | better |
| Personalization | Adapt to listener-specific goals or preferences |

VI. 190: Compute Source with Highest Expected Utility

A person in a multi-speaker environment, like a restaurant, may shift attention from one signal source to another based on several criteria. These criteria are rooted in both the properties of the signal environment and the listener's internal goals or needs.

The following are criteria for attention shifting.

Salient events. Sudden or prominent changes in the environment (e.g., a loud noise, someone calling a name, a phone ringing) involuntarily capture attention, even if focus was elsewhere. This is bottom-up or exogenous attention shifting. Changes in tone, pitch, or volume prompt attention shift.

Mathematical Formulation. Let x_t be the feature vector (e.g., loudness, pitch, timbre) of the incoming sound at time t, and \hat{x}_t the predicted feature vector based on prior context. The salience score S_t is defined as S_t=|x_t−\hat{x}_t|_2. An attention shift is triggered if S_t>θ_{salience}, where θ_{salience} is a threshold learned from behavioral or neural data.

Pauses or gaps. Attention shifts often occur during brief pauses or moments of low intensity in the current sound source, which unmask other sounds and provide an opportunity to redirect attention. This is referred to as acoustic glimpsing.

Mathematical formulation. Let E_{att}(t) be the instantaneous energy of the attended source. The SA process detects a gap if E_{att}(t)<θ_{gap}, where θ_{gap} is a low-energy threshold. The probability of shifting increases during these intervals.

Task relevance/interest. If another source becomes more relevant or interesting (e.g., a new conversation topic, music starting), top-down or endogenous attention may shift voluntarily to that source. Attention shifts to a source that provides critical information or instructions relevant to a task.

Mathematical formulation. Let U_i(t) be the expected utility of attending to source i at time t. The listener shifts attention from source j to source k if U_k(t)−U_j(t)>θ_{utility}, where θ_{utility} is a decision threshold reflecting the cost of shifting.

Cognitive load/comprehension. If the current source becomes hard to follow or less comprehensible, the listener may shift to an easier or more rewarding source. Prolonged attention to one source may lead to fatigue or boredom, prompting a shift for variety or rest.

Mathematical formulation. Let L_j(t) be the cognitive load of source j, and let L_{max} be the maximum sustainable load. Shift is triggered if L_j(t)>L_{max}. Alternatively, if comprehension probability P_{comp}(j, t) falls below a threshold θ_{comp}:P_{comp}(j, t)<θ_{comp}.

Expectation or anticipation. If the listener expects important information from another source (e.g., waiting for an announcement), attention may shift preemptively.

Mathematical formulation. Let P_{event}(k, t) be the predicted probability of a relevant event from source k. Then P_{event}(k, t)>θ_{expect} triggers a shift from the current source to source k.

Emotional connection. A person may shift attention to a source that sparks emotions, such as excitement, concern, or curiosity.

Mathematical formulation. This is represented by the expected utility U_i(t) of attending to source i at time t. Emotional salience increases the perceived utility, making it more likely that attention will shift to that source. Emotional triggers are a core part of what makes a source “relevant” or “interesting”. For example, if a conversation suddenly becomes exciting or a background sound sparks concern, the expected utility U_k(t) for that source rises, potentially exceeding the threshold for attention shifting.

All of these criteria may be unified under the principle of maximizing utility of information within constraints of limited attentional resources. In other words, attention shifts occur when the expected benefit (informational, social, or emotional) of attending to a new source outweighs that of the current source, factoring in both external salience and internal goals.

Thus, the unified criterion is that attention shifts to the source that currently offers the highest expected utility (relevance, importance, or salience) to the listener, given both external events and internal goals, within the limits of attentional capacity.

Switching Decision. Switch_Attention=f(Expected_Utility_New_Source>Current_Utility+Switching_Cost), where Expected_Utility incorporates all the criteria above, Switching_Cost includes the cognitive effort of disengaging and reorienting, and temporal discounting affects how future utility is weighted, e.g., using a discount factor.

Mathematical formulation. Shift to source k if U_k(t)−U_j(t)>θ, where U_k(t) is a function of salience, relevance, cognitive load, fatigue, and expected events for each source, and θ is a threshold encoding attentional inertia or switching cost.

This unified model suggests that an AI system for selective attention should (i) continuously estimate utility for all available sources, (ii) predict content relevance based on context and user history, (iii) model social relationships and hierarchies, (iv) detect urgency signals and emotional content, (v) account for cognitive load and user state, and (vi) learn individual preferences and attention patterns.

TABLE VIII below is a summary table for utility-based source determination.

TABLE VIII
Summary of utility-based source determination

| Criterion | Mathematical Condition | Key Variables |
|---|---|---|
| Salient Events | S_t > θ_{salience} | Feature vectors, |
| | | prediction error |
| Pauses/Gaps | E_{att}(t) < θ_{gap} | Signal energy |
| Task Relevance | U_k(t) − U_j(t) > | Expected utility |
| | θ_{utility} | |
| Cognitive Load | L_j(t) > L_{max} or | Load, |
| | P_{comp} < θ_{comp} | comprehension |
| | | probability |
| Fatigue/ | P_{shift} = f(D_j), | Duration |
| Boredom | df / dD_j > 0 | of attention |
| Expectation | P_{event}(k, t) > | Predicted event |
| | θ_{expect} | probability |
| Unified | U_k(t) − U_j(t) > θ | All above, as |
| | | components |
| | | of utility |

A person shifts attention because their brain is constantly performing this utility calculation, automatically directing focus to whichever source promises the highest expected value given their current goals, social context, and cognitive capacity. This explains why someone might interrupt listening to a friend to attend to their name being called, or switch from a boring conversation to interesting music, or immediately focus on a sudden loud noise that might signal danger.

### VII. Optimal Method to Present Suppressed Signals to the User

The SA process allows a user to attend or listen to only one signal source at a time. When multiple sources generate signals at the same time, all of them except one are suppressed from the user for the time being. The utilities of all suppressed signals are calculated. Only those suppressed signals that have high utility are then presented to the user in some sequence as the opportunity arises.

Several considerations arise in presenting the suppressed high-utility signals to the user. The utility of a signal can only be calculated after a certain duration of the signal has been observed and analyzed. Hence, the utility of a signal cannot be calculated in real time. The utility of a signal is a function of context in the current communication. If a high-utility signal is presented to the user with a delay, the signal might no longer retain its high utility. Hence, a high-utility signal should be presented to the user as soon as possible. When multiple high-utility signals are queued, the SA process presents them to the user such that the utilities of all these signals are retained as much as possible. Presenting these signals in a FIFO (first in first out) order may not be the best presentation sequence to retain their utilities. The order of signals may need to be rearranged to retain their utilities during presentation.

To present suppressed high-utility signals sequentially, the SA process balances urgency, utility decay, and sequencing—similar to real-time scheduling with deadlines and value decay. This is a challenge in real-time systems and value-aware scheduling, and the optimal solution in this context is as follows. Let S={s_1, s_2, . . . , s_n} be the set of suppressed signals. Each signal s_i has the following properties: (i) u_i(t): utility at time t, t_i\hat{ }{ready}: time at which full utility can be computed, i.e., after observation window, (iii) t_i\hat{ }{deadline}: time after which utility is negligible or zero, (iv) d_i=t_i\hat{ }{deadline}−t_i\hat{ }{ready}: available window for presentation, (v) τ_i: time needed to present signal s_i, (vi) u_i(t)=u_i\hat{ }{max}·φ_i(t), where φ_i(t)∈[0,1] is a decay function, e.g., exponential or linear. The objective of the SA process is to schedule signals s_i∈S for presentation so that the total retained utility is maximized.

This is a value-decaying scheduling problem. Utilities decay with delay. There are time constraints. Multiple items compete for the user's attention slot. An optimal strategy is to use a greedy value-density scheduler with utility decay. At each free time point, the SA process selects the signal with highest expected retained utility per time unit.

Decay-aware utility scheduling. The input is a list of signals s_i, each with u_i\hat{ }{max}, where φ_i(t) designates a decay function (e.g., φ_i(t)=e\hat{ }{−λ_i·(t−t_i\hat{ }{ready})}), τ_i designates a time to play signal, t_i\hat{ }{ready}, t_i\hat{ }{deadline}.

At time t, the SA process repeats the following operations.
1. Filter: all signals that are ready

$$S\_t = \{ s\_i such that t \geq {t\_i}^{⋀} \{ ready \} and t + ⊤ \_i \leq {t\_i}^{⋀} \{ deadline \} \}$$

2. Score each s_i∈S_t by

$$score\_i ( t ) = ( {u\_i}^{⋀} \{ max \} \cdot φ\_i ( t ) ) / ⊤ \_i$$

This captures retained utility per unit presentation time.
3. Select the signal with the highest score:

$$s *= argmax\_ \{ s\_i ∈ S\_t \} score\_i ( t ) .$$

4. Present s* to the user.
5. Advance time by τ_{*}:t←t+τ_{s*}.
6. Repeat until no presentable signals remain.

An exemplary decay function φ_i(t) uses exponential decay for utility, φ_i(t)=1 if t<t_i\hat{ }{ready},. φ_i(t)=e\hat{ }{−λ_i·(t−t_i\hat{ }{ready})}, if t≥t_i\hat{ }{ready} and t≤t_i\hat{ }{deadline}, and φ_i(t)=0, if t>t_i\hat{ }{deadline}, where λ_i is the decay rate, and is learned from context. Fast-changing conversations imply higher λ. Static info, e.g., background music title, imply lower λ.

For context-aware decay, take λ_i=g(context), e.g., based on topic volatility (from conversation graphs), emotional content (e.g., urgency or surprise), or historical attention shifts.

If a new signal with much higher expected utility becomes ready during playback, the SA process interrupts and reschedules (preemptive scheduling).

The SA process uses reinforcement learning or Bayesian updates based on whether the user responds to a delayed signal. If ignored, increase λ_i. If attended or acted on, decrease λ_i.

TABLE IX below is a summary table.

TABLE IX
Summary of suppression of signals

| Challenge | Solution |
|---|---|
| Utility cannot be computed | Wait until t_i\hat{ }{ready}, then enter |
| in real-time | scheduling queue |
| Utility decays over time | Use decay function φ_i(t) |
| FIFO may not retain utility | Use greedy value-density scheduling |
| Varying urgency/context | Model decay rates λ_i based on context |
| No user feedback | Learn decay rates from implicit behavior |
| | (e.g., missed vs. acted upon signals) |

### VIII. Performance Monitoring

To automatically monitor the performance of the SA process in multisource environments—both online (i.e., as the user is using it) and offline (e.g., at the end of the day when the system is no longer being used)—without requiring any explicit user feedback, the SA process leverages implicit behavioral signals (e.g., head/eye movements, speech alignment, neural decoding if available) and defines self-supervised metrics.

TABLE X below is an overview of performance monitoring.

TABLE X
Overview of performance monitoring

| Mode | Goal | Signals Used | Metrics |
|---|---|---|---|
| Online | Detect and adapt | Real-time behavior | Confidence drift, |
| | to failures quickly | (e.g. gaze, speech) | misalignment, |
| | | | consistency |
| Offline | Summarize daily | Logged behavior + | Accuracy proxies, |
| | performance | model outputs | stability, switch |
| | | | latency |

The following assumptions are made. \hat{A}_t[i, j]: model's estimated attention distribution (listener i attending to source j at time t). \tilde{j}*_t(i): ground-truth or inferred dominant attended source from behavioral signals (e.g., eye gaze, neural response)—not manually labeled, inferred from passive signals. No user interaction is required for feedback.

Real-time confidence monitoring. Let the model's attention confidence for node i be: Conf_t(i)=max_j \hat{A}_t[i, j]. Monitor for (i) confidence dips: Conf_t(i)<θ for several t's, and (ii) high entropy: if attention distribution is too flat: Entropy_t(i)=−sum_j\hat{A}_t[i, j]·log \hat{A}_t[i, j]. If entropy exceeds a threshold, attention is undecided or ambiguous.

Implicit signals (e.g., eye gaze, head pose, speech turn-taking) are used to estimate user's real attention: \tilde{j}*_t(i). Define implicit agreement score: if argmax_j \hat{A}_t[i, j]=\tilde{j}*_t(i), Align_t(i)=1; else Align_t(i)=0. Then track moving average: \overline{Align}_t(i)=EMA_{α}(Align_t(i)), where EMA_{α} is an exponential moving average function with parameter α. Trigger adaptive behavior if \overline{Align}_t(i) drops below a threshold.

Offline performance monitoring. Define T: total active time, \hat{j}*_t(i)=argmax_j \hat{A}_t[i, j], and \tilde{j}*_t(i): passively inferred ground-truth attention. Then the proxy attention accuracy is given by Accuracy_{proxy}(i)=(1/T)·\sum_{t=1}\hat{ }{T}[1]·[\hat{j}*_t(i)=\tilde{j}*_t(i)], where [1] is a vector.

When the inferred attention \tilde{j}*_t(i) changes, compute delay until model matches:

```
for each switch_time t_s:
  if \tilde{j}*_t(i) changes:
    wait until t′ > t_s where \hat{j}*_{t′}(i) == \tilde{j}*_{t_s}(i)
    record latency = t′ − t_s
```

Average this over a length of time (e.g., a day) to obtain mean switch latency.

Measure how often attention unnecessarily oscillates: Stability_t(i)=[1]·[\hat{j}*_t(i)=\hat{j}*_{t−1}(i)], where [1] is a vector. Define: StabilityRate_T(i)=(1/(T−1))·\sum_{t=2}\hat{ }{T} Stability_t(i). Low StabilityRate implies unstable, indecisive attention.

TABLE XI below is a summary of key metrics.

TABLE XI
Summary of key metrics for performance monitoring

| Metric | Definition | Mode | Insight |
|---|---|---|---|
| Confidence | \max_j \hat{A}_t[i, j] | Online | Model certainty |
| Entropy | −\sum_j \hat{A}_t[i, j] \log | Online | Decision |
| | \hat{A}_t[i, j] | | ambiguity |
| Align | Match between model and | Both | Behavioral |
| Score | inferred attention | | correctness |
| Proxy | \sum [1] . [ \hat{j}*_t = | Offline | Approximate |
| Accuracy | \tilde{j}*_t ] | | correctness |
| Switch | Delay between inferred and | Offline | Adaptation lag |
| Latency | actual switch | | |
| Stability | Proportion of time with | Offline | Decision |
| Rate | consistent attention | | smoothness |

Advantages of the SA process monitoring include (i) fully self-monitoring, (ii) requires no explicit feedback, (iii) uses passive, implicit behavioral signals, and (iv) enables continuous adaptation and improvement.

What is claimed is:

1. A selective attention system for multi-source or multi-speaker environments, comprising:
a plurality of independent selective attention (SA) models, each configured to output a probability distribution over a plurality of sources and a confidence score;
a modular framework allowing said SA models to be added, replaced, upgraded or blocked in real time without interrupting system operation;
an output fuser configured to combine outputs from said SA models based on at least one of model confidence and dynamically learned reliability scores; and
a routing mechanism that directs user attention to a single source at a time based on the fused output.

2. The system of claim 1, wherein the plurality of SA models include heterogeneous modalities selected from the group consisting of: audio-only, video-only, text-based, multimodal and beamforming models.

3. The system of claim 1, wherein said output fuser comprises a self-attention mechanism or a multilayer perceptron adaptively weighting SA model outputs.

4. The system of claim 1, further comprising a conflict resolver resolving disagreements among high-confidence SA models using trust-weighted voting, entropy-based heuristics or prior knowledge of model strengths.

5. The system of claim 1, wherein system performance is monitored automatically without explicit user feedback by measuring at least one of: (a) model agreement or disagreement, (b) temporal consistency of confidence scores, and (c) post-hoc regret estimation.
